(19) United States
(12) Patent Application Publication
(10) Pub. No.: US 2012/0110309 A1
(43) Pub. Date: May 3, 2012

(54) Data Output Transfer To Memory

(75) Inventors: Laurent Lefebvre, Mascouche (CA); Michael Mantor, Orlando, FL (US); Robert Hankinson, Orlando, FL (US)

(73) Assignees: Advanced Micro Devices, Inc., Sunnyvale, CA (US); ATI Technologies ULC, Markham (CA)

(21) Appl. No.: 12/916,163

(22) Filed: Oct. 29, 2010

(51) Int. Cl. G06F 9/312; G06F 12/00

(52) U.S. Cl. 712/225; 711/154; 711/E12.001; 712/E09.033

(57) ABSTRACT

Methods, systems, and computer readable media for improved transfer of processing data outputs to memory are disclosed. According to an embodiment, a method for transferring outputs of a plurality of threads concurrently executing in one or more processing units to a memory includes: forming, based upon one or more of the outputs, a combined memory export instruction comprising one or more data elements and one or more control elements; and sending the combined memory export instruction to the memory. The combined memory export instruction can be sent to memory in a single clock cycle. Another method includes: forming, based upon outputs from two or more of the threads, a memory export instruction comprising two or more data elements; embedding at least one address representative of the two or more of the outputs in a second memory instruction; and sending the memory export instruction and the second memory instruction to the memory.

### BACKGROUND OF THE INVENTION

1. Field of the Invention

The present invention relates generally to the transferring of data processing outputs to memory.

2. Background Art

A processor, such as, for example, a central processor unit (CPU), a graphics processor unit (GPU), or a general purpose GPU (GPGPU) can have one or more processing units. Other processors are also known to have multiple processing units. In some multiple processing unit configurations, these multiple processing units can concurrently execute the same instruction upon multiple data elements. Such processing units that execute an instruction on multiple data elements are referred to as single instruction multiple data (SIMD) processors.

SIMD processing is well suited for applications that have a high degree of parallelism such as graphics processing applications, protein folding applications, and many other compute-heavy applications. For example, in a graphics processing application, each pixel and/or each vertex can be represented as a vector of elements. The elements of a particular pixel can include the color values such as red, blue, green, and an opacity (alpha) value (e.g., R,B,G,A). The elements of a vertex can be represented as position coordinates X, Y, and W. Vertices are also often represented with the position coordinates together with a fourth parameter used to convey additional information—X,Y,W,Z. In addition to pixels and vertices, numerous other types of data can be represented as vectors. Each data element of the vector can be processed by a separate SIMD processing unit.

The communication bandwidth available to transfer the data output from the processing units to memory is, in generally, limited to less than the aggregate data output that can be produced by the processing units. The transferring of data outputs to memory can therefore be expensive in terms of the clock cycles that are required. In conventional systems, the data to be transferred and the address of the location in memory to be written are sent in separate memory instructions. Thus, in general, the output corresponding to each input vector requires two clock cycles in order to be written into memory: a write address is sent in the first clock cycle, and the output data is sent in the second cycle. When multiple processing units, such as in a SIMD processor, are operating in parallel and producing concurrent output, it is even more important that the output is efficiently written to memory. Furthermore, in conventional systems the output from each processing unit is separately transferred to memory resulting in partial output bus utilization.

What are needed, therefore, are methods and systems to improve the transferring of outputs to memory.

### BRIEF SUMMARY OF EMBODIMENTS OF THE INVENTION

Methods, systems, and computer readable media for improved transfer of processing data outputs to memory are disclosed. According to an embodiment, a method for transferring outputs of a plurality of threads concurrently executing in one or more processing units to a memory is disclosed. The method includes forming, based upon one or more of the outputs, a combined memory export instruction comprising one or more data elements and one or more control elements; and sending the combined memory export instruction to the memory. The combined memory export instruction can be sent to memory in a single clock cycle.

According to another embodiment, a method for transferring outputs of a plurality of threads concurrently executing in one or more processing units to a memory includes: foaming, based upon outputs from two or more of the threads, a coalesced memory export instruction comprising two or more data elements; embedding at least one address representative of the two or more of the outputs in a second memory instruction; and sending the coalesced memory export instruction and the second memory instruction to the memory.

A system embodiment for transferring outputs of a plurality of threads to a memory comprises one or more processing units communicatively coupled to a memory controller and configured to concurrently execute the plurality of threads, and a memory export instruction generator. The memory export instruction generator is configured to form, based upon one or more of the outputs, a combined memory export instruction comprising one or more data elements and one or more control elements.

Another system embodiment for transferring outputs of a plurality of threads to a memory comprises one or more processing units communicatively coupled to a memory controller and configured to concurrently execute the plurality of threads, and a thread coalescing module. The thread coalescing module is configured to identify two or more of the outputs of respective ones of the threads addressed to adjacent memory locations; embed the two or more of the outputs in a coalesced memory export instruction; embed an address of one of the adjacent memory locations in a second memory export instruction; send the coalesced memory export instruction to the memory in one clock cycle; and send the second memory export instruction in a second clock cycle.

A computer readable media embodiment is disclosed storing instructions that when executed are adapted to transfer outputs of a plurality of threads concurrently executing in one or more processing units to a memory. The computer readable media embodiment is adapted to transfer outputs to the memory by forming, based upon one or more of the outputs, a combined memory export instruction comprising one or more data elements and one or more control elements; and sending the combined memory export instruction to the memory.

Another computer readable media embodiment is disclosed storing instructions that when executed are adapted to transfer outputs of a plurality of threads concurrently executing in one or more processing units to a memory. The computer readable media embodiment is adapted to transfer outputs to the memory by: forming, based upon outputs of two or more of the threads, a memory export instruction comprising two or more data elements; embedding at least one address representative of the outputs in a second memory instruction; and sending the memory export instruction and the second memory instruction to the memory.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The accompanying drawings, which are incorporated in and constitute part of the specification, illustrate embodiments of the invention and, together with the general description given above and the detailed description of the embodiment given below, serve to explain the principles of the present invention. In the drawings:

FIG. 1 illustrates a method for combined transfer of control and data in accordance with an embodiment of the present invention.

FIGS. 2a and 2b illustrate combined memory export instructions, according to an embodiment of the present invention. FIG. 2c illustrates a coalesced memory export instruction, according to an embodiment of the present invention. FIG. 2d illustrates a memory instruction to send address information, according to an embodiment of the present invention.

FIG. 3 illustrates a method for creating a combined memory export instruction, in accordance with an embodiment of the present invention.

FIG. 4 illustrates a method for transmitting data outputs from a plurality of threads and control information, according to an embodiment of the present invention.

FIG. 5 illustrates a system for combined export of data to memory, according to an embodiment of the present invention.

### DETAILED DESCRIPTION OF EMBODIMENTS OF THE INVENTION

Embodiments of the present invention are directed to improving the performance of processors comprising one or more SIMD processing units. Example environments in which embodiments of the present invention can be practiced include processors having a plurality of processing units, where multiple processing units execute the same instruction stream upon respective data elements. Each processing unit executes a thread. According to an embodiment, the threads executing on the respective processing units execute the same instruction stream. Thus, processing in the respective SIMD processing units is concurrent with respect to each other.

In SIMD environments, application data can be stored, accessed, and processed as vectors. For graphics applications, for example, vertex and pixel data are typically represented as vectors of several elements, such as, X, Y, Z, and W. The X, Y, Z, and W elements can represent various parameters depending on the particular application. For example, in a pixel shader, X, Y, Z, and W can correspond to pixel elements such as the color components R, B, G and alpha or opacity component A. In the following description, the term “vector element” or “data element” is intended to refer to one data component of a vector, such as, one of X, Y, Z, or W components. Although graphics applications are used as exemplary applications for purposes of description, any application for which SIMD processing is suited can be implemented according to the teachings of this disclosure.

The processing output from each of the threads and/or processing units, is transferred to a memory. The memory can either be on the same chip as the processing units, or off-chip. The transferring of output data to memory includes the transmission of the output data from the processing units producing the outputs to the memory or corresponding memory controller, over a communication infrastructure coupling the memory (or memory controller) to the processing units. The transfer includes transmission of the data and the corresponding instruction type code, which specifies to the receiver the type of operation required. In many systems, each thread is configured to output its data as a vector of elements. For example, each thread can output its data in a vector of X, Y, Z, W form. The communications infrastructure between the thread processing units and the memory is, in general, limited in the amount of data that can be simultaneously transmitted. For example, according to an embodiment, each of sixteen processing units or threads may output up to 128 bits of data (4 data elements of 32 bits each) in a clock cycle, but the bus interconnecting the processing units to the memory, and/or the inputs interfaces to the memory, may be restricted to only 8 separate interfaces of 128 bits each with a separate address for each of the 128 bit vector elements. Also, in conventional systems, the output of each processing unit is transferred to memory by first transmitting an address where the data should be written to in the memory, and then sending the data in the next clock cycle.

Frequently, however, one or more processing units or threads do not output sufficient data to fill all X, Y, Z, W elements of an output vector. According to one embodiment, when the respective output vectors of threads are not fully populated, the present invention combines control information and data of 2 partially populated threads into one fully populated combined memory export instruction that can be transferred to memory in a single clock cycle. Thus, in one embodiment, the present invention speeds up the writing of outputs to memory by opportunistically using potentially unutilized bandwidth in the data bus in order to transmit control information, such as the address in memory where the data is to be written to. According to another embodiment, the present invention combines the data outputs of two or more threads to more efficiently utilize the data bus bandwidth in each clock cycle. Combining data and control information from one thread, and/or combining data and control information from more than one thread leads to substantial improvements in processing efficiencies by reducing the time required for transferring processing outputs to memory.

Embodiments of the present invention may be used in any computer system, computing device, entertainment system, media system, game systems, communication device, personal digital assistant, or any system using one or more processors. The present invention is particularly useful where SIMD processing can be advantageously utilized.

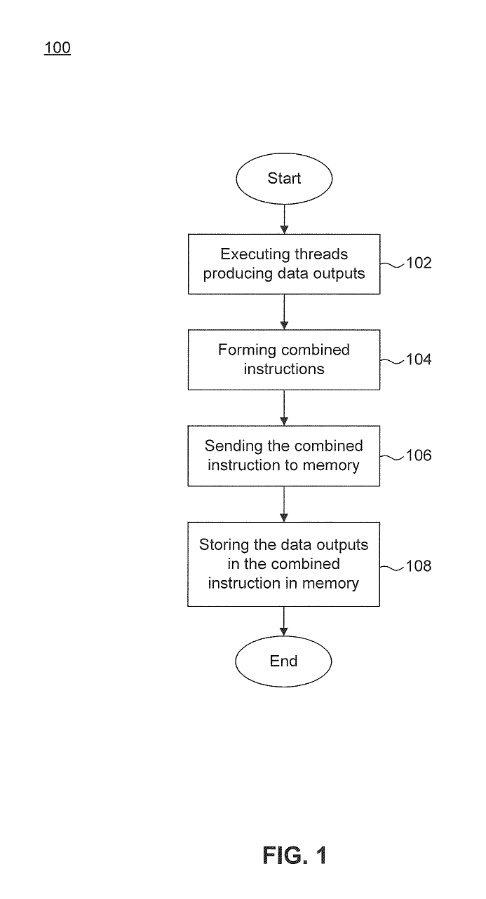

FIG. 1 illustrates a method 100 for combining data and control in an instruction, according to an embodiment. Method 100 can, for example, be used to combine control information and data outputs when an individual thread outputs less than the maximum amount of data elements that can be accommodated in a memory export instruction.

In step 102, a plurality of threads are executed on a processor. According to an embodiment, respective threads are executed on separate processing units. As described above, the threads can be for processing vectors of input data. Each thread can output a vector of data. According to an embodiment, each thread can output up to four data elements, each data element being 32 bits in size. For example, the output of each thread can be a vector comprising of X, Y, Z, and W elements, as described above. The processing units can be SIMD processing units, and the threads can be executing the same instruction stream. The threads can be any SIMD processing tasks.

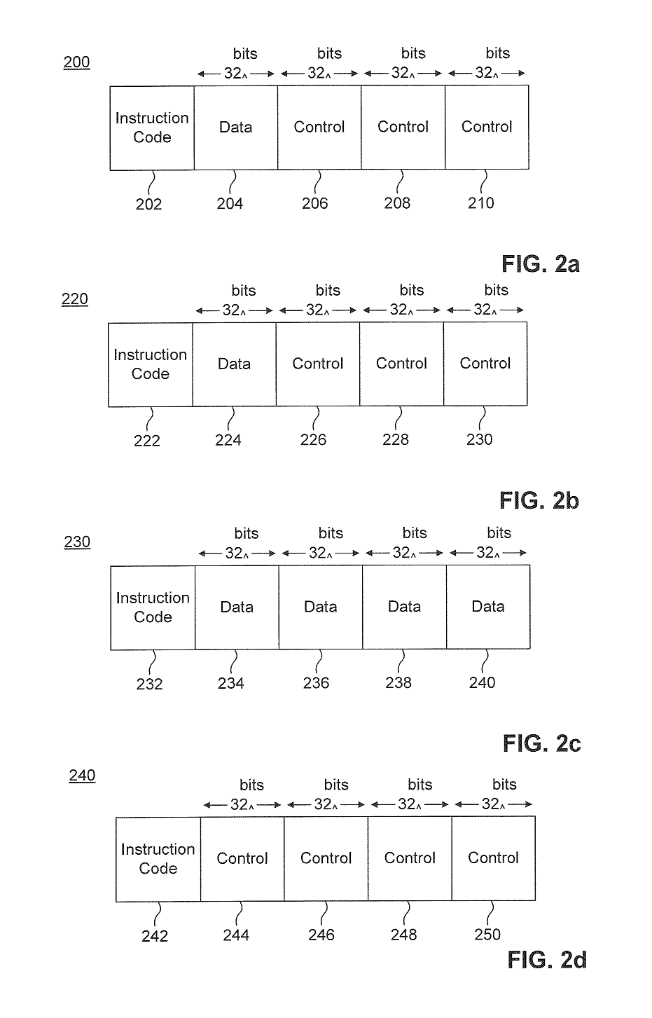

In step 104, combined memory export instructions are formed according to an embodiment of the present invention. The combined memory export instruction comprises one or more data elements output from a thread and one or more control elements. The control elements can include, for example, the address in memory where the data elements are to be written. The forming of the combined memory export instruction is further described in relation to FIG. 2 below.

In step 106, the combined memory export instruction is sent to memory. According to an embodiment, the combined memory export instruction is sent to memory in a single clock cycle. For example, the combined memory export instruction is of a size less than or equal to the size or bandwidth of an individual interface to the memory. The bus size refers to the bandwidth of the input interfaces to the memory from the processing units. Transmitting the combined memory export instruction to memory includes transmitting the address information of the write location and the one or more data elements, in parallel, on a data bus to memory. Other control information, such as a base address of a memory area, can be made available to a memory controller through one or more registers that are accessible to devices including the memory controller.

In step 108, the data from the combined memory export instruction is received at a memory controller and subsequently stored in memory. According to an embodiment, the memory controller determines that the received instruction is a combined instruction. The determination that the received instruction is a combined instruction can be made based upon an instruction code associated with the received instruction. According to an embodiment, the instruction type code can be included with the received instruction. In another embodiment, the instruction type code can be separately indicated to the memory controller, for example, using a separate control bus, or register.

After determining the instruction type code, or more particularly, the memory instruction type, of the received instruction, the memory controller can determine how the data in the received instruction is to be stored. According to an embodiment, the received combined memory export instruction can include one control data element and up to three data elements. According to an embodiment, the control element can include an address in memory, and the data elements can include one data element to be stored at the address, or two or more data elements to be stored at consecutive memory block addresses. According to another embodiment, the received instruction can include one data element and one or more control elements. For example, the control elements can include an address at which to store the data, a comparison data to which the data currently at the address in memory to be compared with, and a return address to which any results of the comparison are to be written. In addition to the examples of combined memory export instructions described above, a person of skill in the art would understand that other types of combined memory export instructions having data elements and various control elements are possible.

FIG. 2a illustrates an exemplary combined memory export instruction 200, according to an embodiment of the present invention. Exemplary combined memory export instruction 200 includes an instruction type code 202 indicating the memory operation type, a data element 204, and three control elements. According to an embodiment, the instruction type code indicates to the receiver that this instruction is a combined memory export instruction that includes a data element in the first field, followed by three control elements. Fields in the combined memory export instruction can be of a fixed or variable size. In an embodiment, each field is 32-bits wide, corresponding to a double word (dword) data type. The control elements can represent an offset indicating the offset from a base address in memory, a compare data element representing data used in a comparison operation with the current contents at offset, and a return address element indicating where the result of the comparison should be written to. The base address can, for example, either be predetermined or be available from a register. According to an embodiment, combined memory export instruction 200 can be used for compare-and-set or return-exchange operations. Based upon the instruction type code 202, the receiving device, such as a memory controller, is able to determine that the data would be found in the first element, and the particular types of control information is to be found in the corresponding respective fields.

FIG. 2b illustrates a second exemplary combined memory export instruction 220, according to another embodiment of the present invention. Exemplary combined memory export instruction 220 includes two data fields 222 and 224, and two control fields 226 and 228. According to an embodiment, combined memory export instruction 220 can be used to support structured buffer data structures. For example, control element 226 can be an index indicating an identifier of the structured buffer in memory, and control element 228 can be an offset indicating where in that structured buffer the data in elements 222 and 224 is to be written. Data elements 222 and 224 include data output by one or more threads where the data is destined to be written to consecutive memory blocks, such as in consecutive blocks starting at the offset indicated in the control fields.

FIGS. 2c and 2d illustrate a third and fourth type of memory export instructions, according to embodiments of the present invention. Coalesced memory export instruction 230 includes data elements selected from two or more individual threads. Therefore, two or more of the fields 234, 236, 238, and 240, comprises the outputs of two or more threads respectively. Instruction type code 232 can indicate, to the receiver, that the instruction is a coalesced memory export instruction and the content of the instruction. FIG. 2d illustrates a third type of memory instruction 240. Memory instruction 240 can be used, for example, to send the address of the write location for the data for the data elements included in the coalesced memory export instruction 230. One or more of the fields 242-250 are used to carry control information, such as the write address for data elements carried in another memory export instruction.

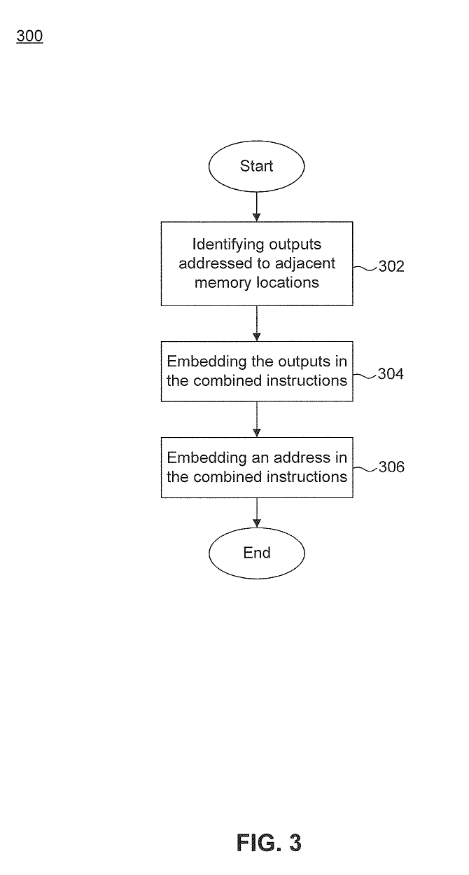

FIG. 3 illustrates a method 300 for creating a combined memory export instruction, according to an embodiment of the present invention. According to an embodiment, in step 302, outputs of one or more threads that can be combined into a single memory export instruction are identified. For example, outputs of one or more threads are identified where the respective outputs are destined for consecutive memory blocks. Consecutive memory blocks, according to an embodiment, include memory blocks of a predetermined step size. According to another embodiment, consecutive memory blocks are determined based on the size of the data elements to be written. Consecutive memory blocks, when the corresponding data elements have been written therein, form a substantially contiguous area in memory. Each memory block can store one or more data elements. Two or more data elements destined to adjacent memory blocks can be determined based upon the address indicated for the respective data outputs. The two or more data elements that are to be combined may belong to the same or different data item, such as, a pixel or a vertex. Thus, the data elements to be combined can come from one or more of the threads.

In step 304, the outputs are embedded in the combined memory export instruction. According to an embodiment, the outputs are embedded in locations determined based on the instruction type code. For example, as shown in FIG. 2b, data elements can be included as data elements 222 and 224. As described above, different instruction types can be created in accordance with the teachings of this disclosure. The different instruction types, which can be differentiable based on their instruction type codes, can be based on the number and locations of the data elements and control elements that are in the respective instruction.

In step 306, an address of the memory location to be written to is embedded in the combined instruction. According to an embodiment, the address is determined to be the first address (e.g. lowest address) at which any of the selected data elements are to be stored in memory. According to an embodiment, the address specifies an offset value from a base address in memory. According to another embodiment, the address can be an absolute address in the memory. Address information can be embedded in one or more of the control elements of the combined memory export instruction. For example, some combined memory export instructions can include only the offset as the location in memory where the data is to be written. Some combined memory export instructions can include, as in FIG. 2b, an index indicating a particular data structure in the memory, as well as an offset within that structure. In some embodiments, a base address may be available to a memory controller via a register.

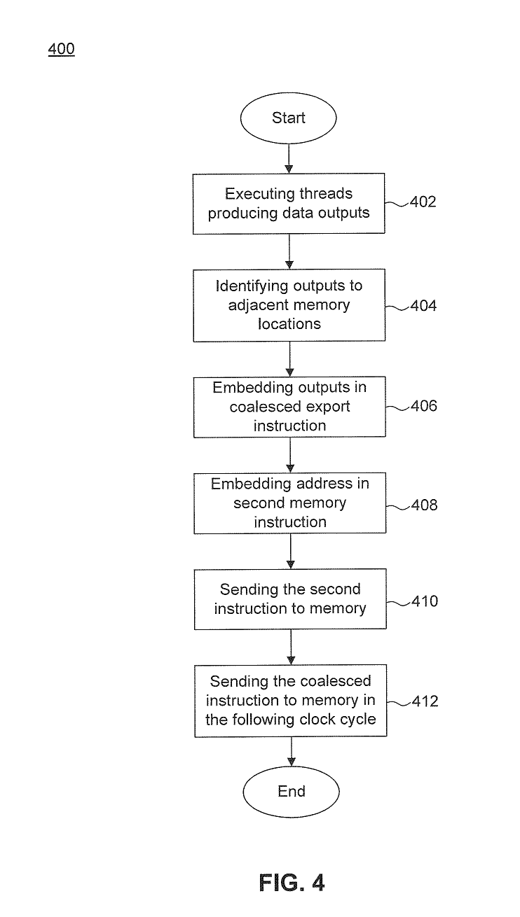

FIG. 4 illustrates a method 400 for combining the outputs of a plurality of threads into an output vector to be written to memory, according to an embodiment of the present invention. In step 402, a plurality of threads are executed on a processor. According to an embodiment, respective threads are executed on separate processing units. As described above, the threads can be for processing vectors of input data. Each thread can output a vector of data. According to an embodiment, each thread can output up to four data elements, each data element being 32 bits in size. For example, the output of each thread can be a vector comprising of X, Y, Z, and W elements, as described above. The processing units can be SIMD processing units, and the threads can be executing the same instruction stream. The threads can be any SIMD processing tasks.

In step 404, threads that are outputting data to neighboring memory locations are identified. According to an embodiment, the write address for each thread's outputs are compared to determine which of the outputs are to be written to consecutive memory blocks. Each memory block can accommodate one or more data elements output by a thread. According to an embodiment, one or more threads can each have one or more outputs destined for consecutive memory blocks.

In step 406, the outputs identified as being destined for neighboring memory locations are embedded in a coalesced memory export instruction. According to an embodiment, the outputs of up to 4 threads are combined to one coalesced memory export instruction, which is configured to carry 128 bits, or 4 data elements of 32 bits each. The outputs from threads can be embedded in the instruction as data elements in increasing order of destination memory addresses.

In step 408, the lowest memory address for writing to the memory, if not already determined in a preceding step, is determined for the data elements embedded in the coalesced memory export instruction. The determined memory address is embedded in a second memory instruction. According to an embodiment, the embedded memory address is 32 bits.

In steps 410 and 412, the output data and the address information is sent to the memory. In step 410, according to an embodiment, the second memory instruction containing the address information is set to the memory in one clock cycle. According to an embodiment, in the second memory instruction, 32 bits or more can be populated with address information. According to an embodiment, address information up to a 128 bits, or the bandwidth of the data bus to memory, can be used for transmitting address information. The memory controller receives the second instruction, decodes it based on an instruction code associated with the second instruction, and extracts the address. The received address is used to access a memory location for writing any data elements that are received in the first instruction.

In step 412, the coalesced memory export instruction containing the data elements from one or more threads is sent to the memory. According to an embodiment, the coalesced memory export instruction sent in a single clock cycle after the clock cycle in which the instruction containing the corresponding address information was sent. Upon receiving the coalesced memory export instruction, the memory controller, according to an embodiment, decodes the instruction code and based on the instruction code determines the format of the instructions. Based on the determined format of the instruction, the memory controller can extract the one or more data elements. The one or more data elements can then be written into the memory at the address provided in the address instruction received in the previous clock cycle.

As described above, method 400 enables the combining of outputs from two or more threads so that the available bandwidth, for example, the entire bandwidth of the one or more data buses, from the processing units to the memory is better utilized. If, for example, 4 threads are detected with output addresses corresponding to neighboring memory blocks, those four outputs can be used to fully populate a 4 element coalesced memory export instruction. By combining outputs of different threads, the total internal bandwidth required to transfer the outputs of the processing units is substantially reduced. The reduction in the memory transfer bandwidth facilitates faster thread execution and overall performance improvements in the system.

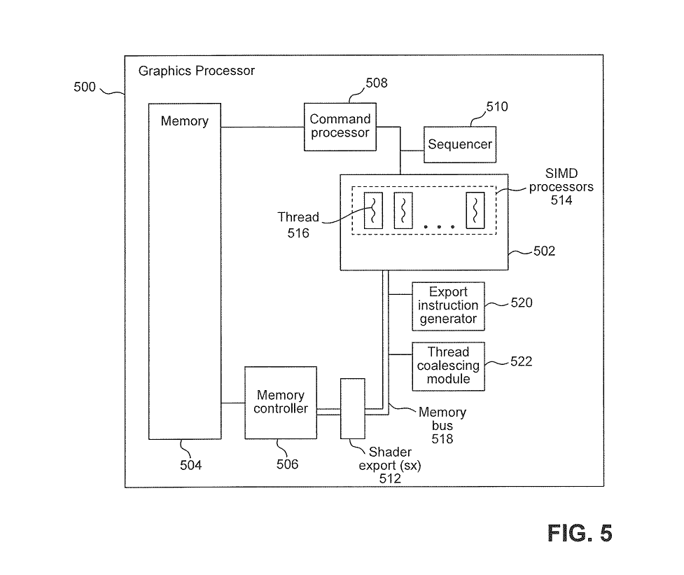

FIG. 5 illustrates a system 500 for combined export of data from one or more concurrent threads, and address information to memory, according to an embodiment of the present invention. System 500 includes a processor 502 comprising a plurality of processing units 514. The processor can be any processor, such as, but not limited to, a CPU, a GPU, a GPGPU, a digital signal processor (DSP), a field programmable gate array (FPGA), application specific integrated circuit (ASIC), or other custom processor. Each processing unit 514 includes a SIMD processing unit which can implement one or more threads 516. According to an embodiment, each SIMD processing unit includes a vector processing engine having four vector processing elements, and a scalar processing engine. During the execution of a method, such as method 100 or method 400 described above, the respective threads 516 can be engaged in processing multiple streams of data using the same instruction stream.

System 500 can also include a memory 504, a memory controller 506, a memory bus 518, an export instruction generator module 520, and a thread coalescing module 522. Memory 504 can be any volatile memory, such as dynamic access random access memory (DRAM). Memory controller 506 includes logic to decode memory instructions received, such as, but not limited to the instructions illustrated in FIGS. 2a-2d, and to write to and/or read from the memory 504 according to the decoded memory instructions. Memory bus 518 can include one or more communication buses coupling, either directly or indirectly, the processing units to a memory controller. According to an embodiment, memory bus 518 includes one or more data buses and one or more control bus. According to an embodiment, memory bus 518 can comprise of sixteen 128 bit data buses from the processing units to a shader export module 512, a 128 bit bus for the output of each processing unit, and only eight buses from shader export 512 to memory 504. In such environments, in particular, the improvements yielded by the methods of combining memory instructions can yield substantial improvements.

The export instruction generator module 520 includes logic to generate memory export instructions that combine output data and address information into a single instruction. According to an embodiment, export instruction generator module 520 can perform steps 104-106 of method 100.

Thread coalescing module 522 includes logic to combine the data outputs of two or more threads to a single export instruction. According to an embodiment, thread coalescing module 522 combines the outputs of two or more of the processing units 514 into a single export instruction and sends the combined export instruction associated in a single clock cycle. The address for the data can be sent in a separate instruction, or in the same instruction. According to an embodiment, thread coalescing module 522 can perform steps 304-312 of method 400 to combine the outputs of two or more processing units in order to more efficiently write output of the processing units to memory.

According to an embodiment, system 500 can also include a command processor 508, a sequencer 510, and a shader export 512. Command processor 508 can include the logic, for example, to generate instructions to be processed by processor 502. Sequencer 510 includes the control logic for the processor 502 and can, for example, include logic to assign data streams to the various processing units 514 and to coordinate the execution of threads and synchronization of data to/from memory and processing units. Shader export 512 can, for example, include logic to perform any processing on data outputs that are being transmitted to memory. According to an embodiment, export instruction generator 520 and thread coalescing module 522 can be implemented in shader export 512.

The embodiments described above can be described in a hardware description language such as Verilog, RTL, netlists, etc. and that these descriptions can be used to ultimately configure a manufacturing process through the generation of maskworks/photomasks to generate one or more hardware devices embodying aspects of the invention as described herein.

Embodiments of the present invention yield several advantages over conventional methods of transferring processing outputs to memory. By opportunistically combining data outputs from one or more processing units and address information associated with the data outputs, embodiments of the present invention better utilize the entire communication bandwidth available from the processing units to the memory in order to yield substantially faster transfers of the output data to memory.

### CONCLUSION

The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method for transferring outputs of a plurality of threads concurrently executing in one or more processing units, the method comprising:
forming, based upon one or more of the outputs, a combined memory export instruction comprising one or more data elements and one or more control elements; and
transmitting the combined memory export instruction to the memory.

2. The method of claim 1, wherein the transmitting comprises:
transmitting the combined memory export instruction in one clock cycle.

3. The method of claim 1, further comprising:
storing the one or more data elements in a memory in locations determined based upon the one or more control elements.

4. The method of claim 3, wherein the one or more control elements comprises at least one address in said memory.

5. The method of claim 1, wherein the forming comprises:
identifying two or more of the outputs of respective ones of the threads addressed to adjacent memory locations; and
embedding the two or more of the outputs in the combined memory export instruction.

6. The method of claim 5, wherein the forming further comprises:
embedding one or more addresses of the adjacent memory locations in the combined memory export instruction.

7. The method of claim 1, wherein the processing units comprise single instruction multiple data (SIMD) processing units.

8. A method for transferring outputs of a plurality of threads concurrently executing in one or more processing units, the method comprising:
forming, based upon outputs from two or more of the threads, a coalesced memory export instruction comprising two or more data elements;
embedding at least one address representative of the outputs in a second memory instruction; and
transmitting the coalesced memory export instruction and the second memory instruction.

9. The method of claim 8, the transmitting further comprising:
transmitting the second memory instruction in a first clock cycle; and
transmitting the coalesced memory export instruction in a second clock cycle.

10. The method of claim 8, wherein the forming comprises:
identifying two or more of the outputs of respective ones of the threads addressed to adjacent memory locations; and
embedding the two or more of the outputs in the coalesced memory export instruction.

11. The method of claim 8, wherein the processing units comprise single instruction multiple data (SIMD) processing units.

12. A system for transferring outputs of a plurality of threads, the system comprising:
one or more processing units communicatively coupled to a memory controller and configured to concurrently execute the plurality of threads;
a memory export instruction generator configured to:
form, based upon one or more of the outputs, a combined memory export instruction comprising one or more data elements and one or more control elements.

13. The system of claim 12, further comprising:
a thread coalescing module configured to:
identify two or more of the outputs of respective ones of the threads addressed to adjacent memory locations; and
embed the two or more of the outputs in a coalesced memory export instruction.

14. The system of claim 13, wherein the thread coalescing module is further configured to:
embed an address of one of the adjacent memory locations in a second memory export instruction.

15. The system of claim 14, wherein the thread coalescing module is further configured to:
transmit the coalesced memory export instruction in one clock cycle; and
transmit the second memory export instruction in a second clock cycle.

16. The system of claim 12, further comprising:
a memory controller configured to:
receive memory export instructions including one or more of the combined memory export instruction and coalesced memory export instruction; and
store respective ones of the outputs extracted from the received memory export instructions in locations in the memory, wherein the locations are determined based upon address information received in the memory export instructions.

17. A system for transferring outputs of a plurality of threads, the system comprising:
one or more processing units communicatively coupled to a memory controller and configured to concurrently execute the plurality of threads;
a thread coalescing module configured to:
identify two or more of the outputs of respective ones of the threads addressed to adjacent memory locations;
embed the two or more of the outputs in a coalesced memory export instruction;
embed an address of one of the adjacent memory locations in a second memory export instruction;
send the coalesced memory export instruction in one clock cycle; and
send the second memory export instruction in a second clock cycle.

18. A computer readable media storing instructions wherein said instructions when executed are adapted to transfer outputs of a plurality of threads concurrently executing in one or more processing units by comprising:
forming, based upon one or more of the outputs, a combined memory export instruction comprising one or more data elements and one or more control elements; and
transmitting the combined memory export instruction.

19. The computer readable media of claim 18, wherein the one or more of the outputs are obtained from two or more said threads.

20. A computer readable media storing instructions wherein said instructions when executed are adapted to transfer outputs of a plurality of threads concurrently executing in one or more processing units by comprising:
forming, based upon outputs from two or more of the threads, a coalesced memory export instruction comprising two or more data elements;
embedding at least one address representative of the outputs in a second memory instruction; and
transmitting the coalesced memory export instruction and the second memory instruction.
